(19) United States
(12) Patent Application Publication
(10) Pub. No.: US 2020/0310531 A1
(43) Pub. Date: Oct. 1, 2020

(54) APPARATUS, METHOD, AND PROGRAM PRODUCT FOR DISPLAYING INFORMATION ON A VIRTUAL REALITY HEADSET

(71) Applicant: LENOVO (Singapore) PTE. LTD., New Tech Park (SG)

(72) Inventors: Matthew Davis, Durham, NC (US); Raymond Chen, Durham, NC (US); Guangbo Meng, Beijing (CN); Christopher Miles Osborne, Cary, NC (US)

(21) Appl. No.: 16/370,651

(22) Filed: Mar. 29, 2019

(51) Int. Cl. G06F 3/01; G06F 3/0488; G06F 3/147; G09G 3/00

(52) U.S. Cl. CPC G06F 3/011; G06F 3/0488; G09G 2354/00; G09G 3/001; G09G 2300/02; G06F 3/147

(57) ABSTRACT

Apparatuses, methods, and program products are disclosed for displaying information on a virtual reality headset. One apparatus includes a virtual reality headset. The virtual reality headset includes an inner surface visible to a wearer of the virtual reality headset while the wearer is wearing the virtual reality headset. The virtual reality headset also includes an outer surface not visible to the wearer of the virtual reality headset while the wearer is wearing the virtual reality headset. The virtual reality headset includes a first screen on the inner surface. The virtual reality headset also includes a second screen on the outer surface.

### FIELD

The subject matter disclosed herein relates to virtual reality headsets and more particularly relates to displaying information on virtual reality headsets.

### BACKGROUND

### Description of the Related Art

Information handling devices, such as desktop computers, laptop computers, tablet computers, smart phones, optical head-mounted display units, smart watches, televisions, streaming devices, virtual reality headsets, etc., are ubiquitous in society. These information handling devices may be used for performing various actions. For example, an information handling device may be used to display information.

### BRIEF SUMMARY

An apparatus for displaying information on a virtual reality headset is disclosed. A method and computer program product also perform the functions of the apparatus. In one embodiment, the apparatus includes a virtual reality headset. In some embodiments, the virtual reality headset includes an inner surface visible to a wearer of the virtual reality headset while the wearer is wearing the virtual reality headset. In certain embodiments, the virtual reality headset includes an outer surface not visible to the wearer of the virtual reality headset while the wearer is wearing the virtual reality headset. In various embodiments, the virtual reality headset includes a first screen on the inner surface. In some embodiments, the virtual reality headset includes a second screen on the outer surface.

In some embodiments, the first screen is at least part of a virtual reality screen. In one embodiment, the second screen is configured to display information related to a virtual reality environment experienced by the wearer. In various embodiments, the second screen includes a touch-screen display. In some embodiments, the second screen is configured to display information while the wearer is not wearing the virtual reality headset.

A method for displaying information on a virtual reality headset, in one embodiment, includes displaying first information on a first screen of a virtual reality headset. In such an embodiment, the first screen is on an inner surface of the virtual reality headset, and the inner surface is visible to a wearer of the virtual reality headset while the wearer is wearing the virtual reality headset. In certain embodiments, the method includes displaying second information on a second screen of the virtual reality headset. In such embodiments, the second screen is on an outer surface of the virtual reality headset, and the outer surface is not visible to the wearer of the virtual reality headset while the wearer is wearing the virtual reality headset.

In some embodiments, the first information includes a virtual reality environment. In various embodiments, the second information includes information related to a virtual reality environment experienced by the wearer. In one embodiment, the second screen includes a touch-screen display. In some embodiments, the second screen is configured to display information while the wearer is not wearing the virtual reality headset.

In certain embodiments, the method includes receiving input from a user via the second screen. In some embodiments, the input corresponds to a virtual reality environment. In various embodiments, the method includes enabling selecting an application, downloading an application, starting an application, interacting with application content, downloading an update, changing a setting, viewing a notification, interacting with a notification, or some combination thereof via the second screen. In certain embodiments, the second screen is configured to display a time, an image, a notification, or some combination thereof.

In one embodiment, a program product includes a computer readable storage medium that stores code executable by a processor. The executable code, in certain embodiments, includes code to perform displaying first information on a first screen of a virtual reality headset. In such embodiments, the first screen is on an inner surface of the virtual reality headset, and the inner surface is visible to a wearer of the virtual reality headset while the wearer is wearing the virtual reality headset. The executable code, in various embodiments, includes code to perform displaying second information on a second screen of the virtual reality headset. In such embodiments, the second screen is on an outer surface of the virtual reality headset, and the outer surface is not visible to the wearer of the virtual reality headset while the wearer is wearing the virtual reality headset.

In certain embodiments, the second screen is configured to display information while the wearer is not wearing the virtual reality headset. In one embodiment, the executable code includes code to perform receiving input from a user via the second screen. In certain embodiments, the input corresponds to a virtual reality environment.

In various embodiments, the executable code includes code to perform enabling selecting an application, downloading an application, starting an application, interacting with application content, downloading an update, changing a setting, viewing a notification, interacting with a notification, or some combination thereof via the second screen. In some embodiments, the second screen is configured to display a time, an image, a notification, or some combination thereof.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for displaying information on a virtual reality headset;

FIG. 2 is a schematic block diagram illustrating one embodiment of an apparatus including an information handling device;

FIG. 3 is a schematic block diagram illustrating one embodiment of an apparatus including a virtual reality display module;

FIG. 4 is a schematic block diagram illustrating another embodiment of an apparatus including a virtual reality display module;

FIG. 5 is a perspective drawing illustrating one embodiment of a virtual reality headset;

FIG. 6 is a schematic block diagram illustrating one embodiment of a virtual reality headset;

FIG. 7 is a schematic block diagram illustrating another embodiment of a virtual reality headset;

FIG. 8 is a schematic flow chart diagram illustrating an embodiment of a method for displaying information on a virtual reality headset; and

FIG. 9 is a schematic flow chart diagram illustrating another embodiment of a method for displaying information on a virtual reality headset.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification have been labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

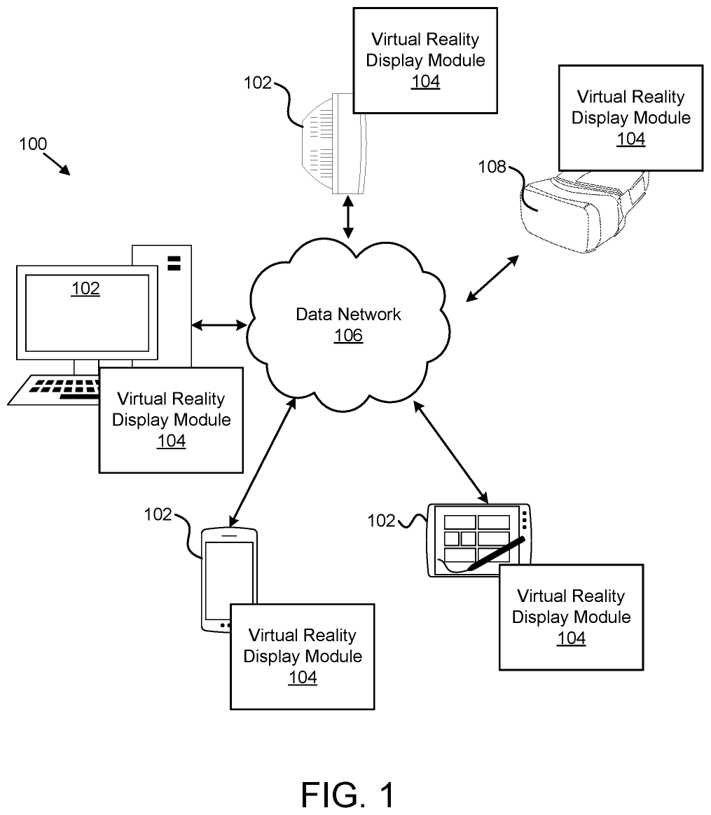

FIG. 1 depicts one embodiment of a system 100 for displaying information on a virtual reality headset. In one embodiment, the system 100 includes information handling devices 102, virtual reality display modules 104, data networks 106, and virtual reality headsets 108. Even though a specific number of information handling devices 102, virtual reality display modules 104, data networks 106, and virtual reality headsets 108 are depicted in FIG. 1, one of skill in the art will recognize that any number of information handling devices 102, virtual reality display modules 104, data networks 106, and virtual reality headsets 108 may be included in the system 100.

In one embodiment, the information handling devices 102 include computing devices, such as desktop computers, laptop computers, personal digital assistants (PDAs), tablet computers, smart phones, cellular phones, smart televisions (e.g., televisions connected to the Internet), set-top boxes, game consoles, security systems (including security cameras), vehicle on-board computers, network devices (e.g., routers, switches, modems), streaming devices, or the like. In some embodiments, the information handling devices 102 include wearable devices, such as smart watches, fitness bands, optical head-mounted displays, virtual reality devices, or the like. The information handling devices 102 may access the data network 106 directly using a network connection.

The information handling devices 102 may include an embodiment of the virtual reality display module 104. In certain embodiments, the virtual reality display module 104 may display first information on a first screen of the virtual reality headset 108. In such embodiments, the first screen is on an inner surface of the virtual reality headset 108, and the inner surface is visible to a wearer of the virtual reality headset 108 while the wearer is wearing the virtual reality headset 108. The virtual reality display module 104 may also display second information on a second screen of the virtual reality headset 108. In such embodiments, the second screen is on an outer surface of the virtual reality headset 108, and the outer surface is not visible to the wearer of the virtual reality headset 108 while the wearer is wearing the virtual reality headset 108. In this manner, the virtual reality display module 104 may be used for displaying information on the virtual reality headset 108.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a WAN, a storage area network (“SAN”), a LAN, an optical fiber network, the internet, or other digital communication network. The data network 106 may include two or more networks. The data network 106 may include one or more servers, routers, switches, and/or other networking equipment. The data network 106 may also include computer readable storage media, such as a hard disk drive, an optical drive, non-volatile memory, RAM, or the like.

The virtual reality headset 108 may include any suitable type of headset used to provide a virtual reality experience and/or a virtual reality environment to a wearer of the virtual reality headset 108. In some embodiments, the virtual reality headset 108 includes a heads-up display that enables users to interact with simulated environments and/or experience a first-person view. Moreover, the virtual reality headset 108 may replace a user's (e.g., wearer's) natural environment with virtual reality content such as a movie, a game, or a 360-degree virtual reality environment that enables the user to turn and/or look around as the person would in the physical world.

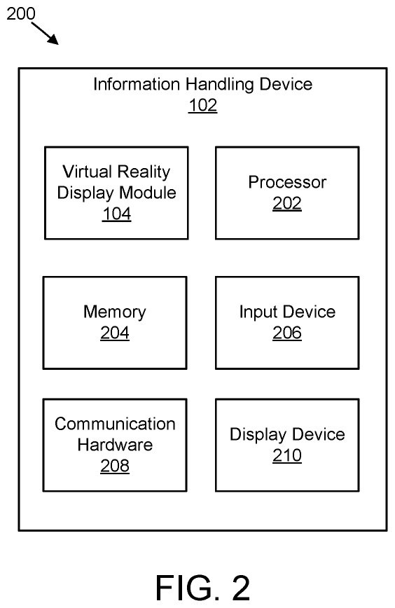

FIG. 2 depicts one embodiment of an apparatus 200 that may be used for displaying information on the virtual reality headset 108. The apparatus 200 includes one embodiment of the information handling device 102. Furthermore, the information handling device 102 may include the virtual reality display module 104, a processor 202, a memory 204, an input device 206, communication hardware 208, and a display device 210. In some embodiments, the input device 206 and the display device 210 are combined into a single device, such as a touchscreen.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the virtual reality display module 104, the input device 206, the communication hardware 208, and the display device 210.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media.

In some embodiments, the memory 204 stores data relating to displaying information on the virtual reality headset 108. In some embodiments, the memory 204 also stores program code and related data, such as an operating system or other controller algorithms operating on the information handling device 102.

The information handling device 102 may use the virtual reality display module 104 for displaying information on the virtual reality headset 108. As may be appreciated, the virtual reality display module 104 may include computer hardware, computer software, or a combination of both computer hardware and computer software. For example, the virtual reality display module 104 may include circuitry, or a processor, used to display first information on a first screen of the virtual reality headset 108. In this example, the first screen is on an inner surface of the virtual reality headset 108, and the inner surface is visible to a wearer of the virtual reality headset 108 while the wearer is wearing the virtual reality headset 108. As another example, the virtual reality display module 104 may include computer program code that displays second information on a second screen of the virtual reality headset 108. In this example, the second screen is on an outer surface of the virtual reality headset 108, and the outer surface is not visible to the wearer of the virtual reality headset 108 while the wearer is wearing the virtual reality headset 108.

The input device 206, in one embodiment, may include any known computer input device including a touch panel, a button, a keyboard, a stylus, or the like. In some embodiments, the input device 206 may be integrated with the display device 210, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel. The communication hardware 208 may facilitate communication with other devices. For example, the communication hardware 208 may enable communication via Bluetooth®, Wi-Fi, and so forth.

The display device 210, in one embodiment, may include any known electronically controllable display or display device. The display device 210 may be designed to output visual, audible, and/or haptic signals. In some embodiments, the display device 210 includes an electronic display capable of outputting visual data to a user. For example, the display device 210 may include, but is not limited to, an LCD display, an LED display, an OLED display, a projector, or similar display device capable of outputting images, text, or the like to a user. As another, non-limiting, example, the display device 210 may include a wearable display such as a smart watch, smart glasses, a heads-up display, or the like. Further, the display device 210 may be a component of a smart phone, a personal digital assistant, a television, a table computer, a notebook (laptop) computer, a personal computer, a vehicle dashboard, a streaming device, or the like.

In certain embodiments, the display device 210 includes one or more speakers for producing sound. For example, the display device 210 may produce an audible alert or notification (e.g., a beep or chime). In some embodiments, the display device 210 includes one or more haptic devices for producing vibrations, motion, or other haptic feedback. For example, the display device 210 may produce haptic feedback upon performing an action.

In some embodiments, all or portions of the display device 210 may be integrated with the input device 206. For example, the input device 206 and display device 210 may form a touchscreen or similar touch-sensitive display. In other embodiments, the display device 210 may be located near the input device 206. In certain embodiments, the display device 210 may receive instructions and/or data for output from the processor 202 and/or the virtual reality display module 104.

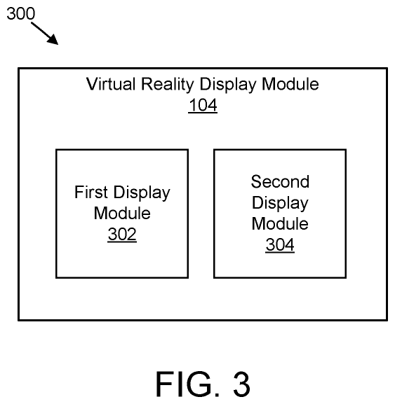

FIG. 3 depicts a schematic block diagram illustrating one embodiment of an apparatus 300 that includes one embodiment of the virtual reality display module 104. Furthermore, the virtual reality display module 104 includes a first display module 302 and a second display module 304.

In certain embodiments, the first display module 302 may display first information on a first screen of the virtual reality headset 108. In such embodiments, the first screen is on an inner surface of the virtual reality headset 108, and the inner surface is visible to a wearer of the virtual reality headset 108 while the wearer is wearing the virtual reality headset 108. In some embodiments, the first information includes a virtual reality environment and/or a virtual reality experience. As may be appreciated, the first screen may include one or more screens for providing a virtual reality environment and/or a virtual reality experience to a wearer of the virtual reality headset 108. In certain embodiments, the first screen may be at least part of a virtual reality screen. In other words, the first screen may be used entirely to provide a virtual reality screen to the wearer, or the first screen may be part of a group of screens used to provide a virtual reality screen.

In one embodiment, the second display module 304 may display second information on a second screen of the virtual reality headset 108. In such an embodiment, the second screen is on an outer surface of the virtual reality headset 108, and the outer surface is not visible to the wearer of the virtual reality headset 108 while the wearer is wearing the virtual reality headset 108. As may be appreciated, the second screen may include one or more screens. In certain embodiments, the second screen is configured to display information related to a virtual reality environment experienced by the wearer. For example, the wearer may take pictures while in their virtual reality environment, and the second screen may display those pictures. As another example, the wearer may be performing a training exercise, and the second screen may show a visual representation of the progress of the training exercise and/or data corresponding to the training exercise. In some embodiments, the second screen may be used as a secondary display, such as for group-based gaming, to enable others around the second screen to engage with the wearer of the virtual reality headset 108. As may be appreciated, the second screen may enable people around the second screen to have a shared experience with the wearer of the virtual reality headset 108 by seeing similar views and/or interacting with the second screen.

In various embodiments, the second screen is configured to display information while the wearer is not wearing the virtual reality headset 108. In certain embodiments, the second screen is configured to display a time, an image, a notification, an application, icons, video, and/or other items, such as while the wearer is not wearing the virtual reality headset 108. For example, while a user is not wearing the virtual reality headset 108, the second screen may display a digital clock, a battery power level (e.g., percentage of battery power remaining), pan images of recent photos, pan images of in-game screenshots, illuminate in response to receiving a notification (e.g., receipt of a text message, an application notification, an indication of an incoming phone call), and so forth. In some embodiments, the second screen includes a touch-screen display to enable a user to perform various operations corresponding to the second screen.

In various embodiments, the second screen is configured to receive input (e.g., via a touch-screen, via voice commands, etc.) from a user. The input may correspond to a virtual reality environment. In other words, the input may enable the user to interact with the virtual reality environment of the wearer, provide updates to the virtual reality environment, and so forth. For example, in some embodiments, the second screen may enable selecting an application (e.g., select a live experience application, select a training application, select a gaming application, select a photography application, etc.), downloading an application, starting an application, interacting with application content (e.g., viewing recently played experiences, recommended experiences, upcoming events, social media content, view information about multi-player virtual reality experience—such as a number of friends participating in a multi-player virtual reality experience, etc.), downloading an update, changing a setting, viewing a notification, interacting with a notification, and/or other functions.

In certain embodiments, the second screen may be activated (e.g., light up, exit a power saving mode, etc.) in response to detecting motion via a motion detector and/or in response to detecting a change in light via a light sensor (e.g., photodetector, photosensor, camera, etc.).

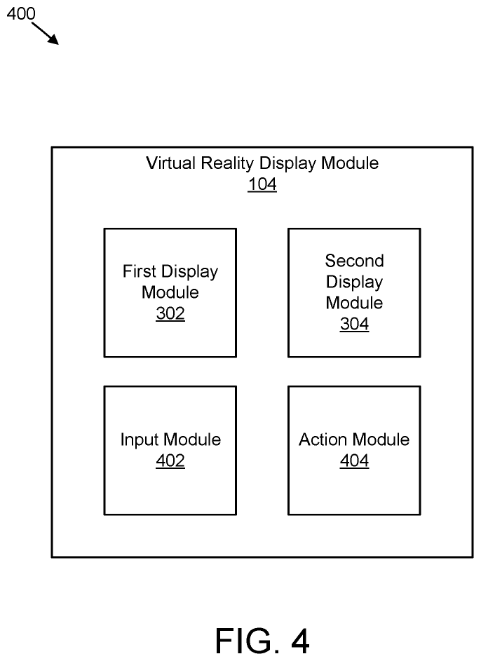

FIG. 4 is a schematic block diagram illustrating another embodiment of an apparatus 400 that includes one embodiment of the virtual reality display module 104. Furthermore, the virtual reality display module 104 includes one embodiment of the first display module 302 and the second display module 304, that may be substantially similar to the first display module 302 and the second display module 304 described in relation to FIG. 3. The virtual reality display module 104 also includes an input module 402 and an action module 404.

In some embodiments, the input module 402 may receiving input (e.g., via a touch-screen, via voice commands, etc.) from a user. The input may correspond to a virtual reality environment. In other words, the input may enable the user to interact with the virtual reality environment of the wearer, provide updates to the virtual reality environment, and so forth.

In certain embodiments, the action module 404 may enable selecting an application, downloading an application, starting an application, interacting with application content, downloading an update, changing a setting, viewing a notification, interacting with a notification, and/or other functions via the second screen. For example, the action module 404 may enable a user to scroll through applications, download updates, change settings, view notifications, and/or launch applications prior to wearing the virtual reality headset 108.

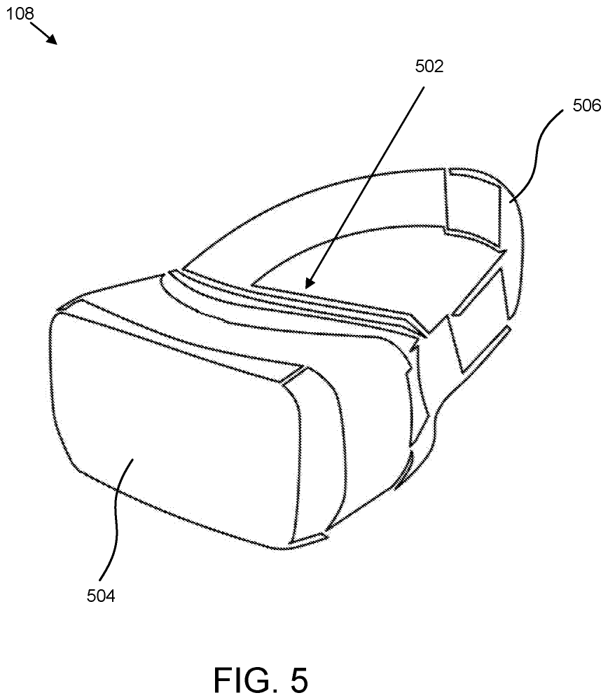

FIG. 5 is a perspective drawing illustrating one embodiment of the virtual reality headset 108. The virtual reality headset 108 includes an inner surface 502 visible to a wearer of the virtual reality headset 108 while the wearer is wearing the virtual reality headset 108. As may be appreciated, a first screen may be located on the inner surface 502. The first screen may include one or more screens.

The virtual reality headset 108 also includes an outer surface 504 not visible to the wearer of the virtual reality headset 108 while the wearer is wearing the virtual reality headset 108. A second screen may be located on the outer surface 504. The virtual reality headset 108 includes a securing device 506 that facilitates attaching the virtual reality headset 108 to a head of the wearer such that the head of the wearer is positioned between the securing device 506 and the inner surface 502 to facilitate the wearer seeing the inner surface 502 while wearing the virtual reality headset 108.

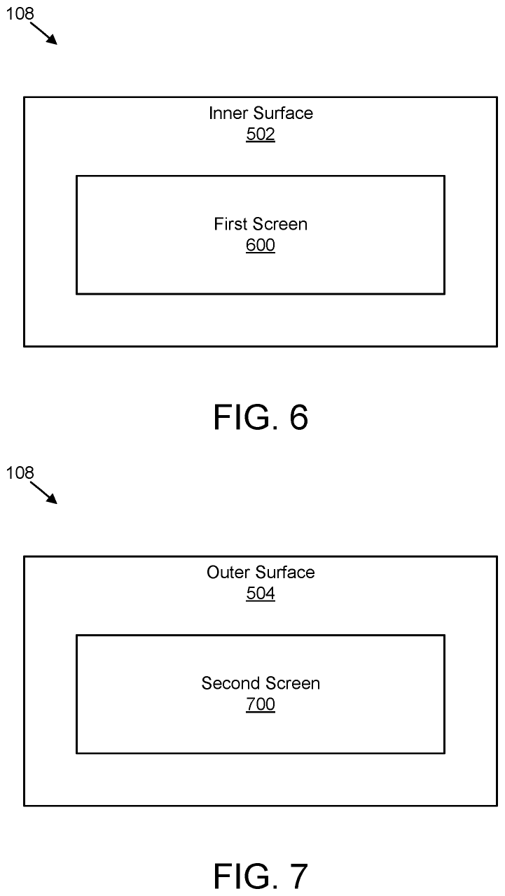

FIG. 6 is a schematic block diagram illustrating one embodiment of the virtual reality headset 108. The virtual reality headset 108 includes the inner surface 502. Moreover, a first screen 600 is on the inner surface 502. As may be appreciated, the first screen 600 may include one or more screens for providing a virtual reality environment and/or a virtual reality experience to a wearer of the virtual reality headset 108. In certain embodiments, the first screen 600 may be at least part of a virtual reality screen. In other words, the first screen 600 may be used entirely to provide a virtual reality screen to the wearer, or the first screen 600 may be part of a group of screens used to provide a virtual reality screen.

FIG. 7 is a schematic block diagram illustrating another embodiment of the virtual reality headset 108. The virtual reality headset 108 includes the outer surface 504. Moreover, a second screen 700 is on the outer surface 504. As may be appreciated, the second screen 700 may include one or more screens. In certain embodiments, the second screen 700 is configured to display information related to a virtual reality environment experienced by the wearer. For example, the wearer may take pictures while in their virtual reality environment, and the second screen 700 may display those pictures. As another example, the wearer may be performing a training exercise, and the second screen 700 may show a visual representation of the progress of the training exercise and/or data corresponding to the training exercise.

In various embodiments, the second screen 700 is configured to display information while the wearer is not wearing the virtual reality headset 108. In some embodiments, the second screen 700 includes a touch-screen display to enable a user to perform various operations corresponding to the second screen 700. For example, the user may contact the second screen 700 via a human finger and/or hand to interact with content on the second screen 700 (e.g., by swiping and/or touching content on the second screen 700). In certain embodiments, the second screen 700 is configured to display a time, an image, a notification, an application, icons, video, and/or other items. In various embodiments, the second screen 700 is configured to receive input (e.g., via a touch-screen, via voice commands, etc.) from a user. The input may correspond to a virtual reality environment. In other words, the input may enable the user to interact with the virtual reality environment of the wearer, provide updates to the virtual reality environment, and so forth. For example, in some embodiments, the second screen 700 may enable selecting an application, downloading an application, starting an application, interacting with application content, downloading an update, changing a setting, viewing a notification, interacting with a notification, and/or other functions.

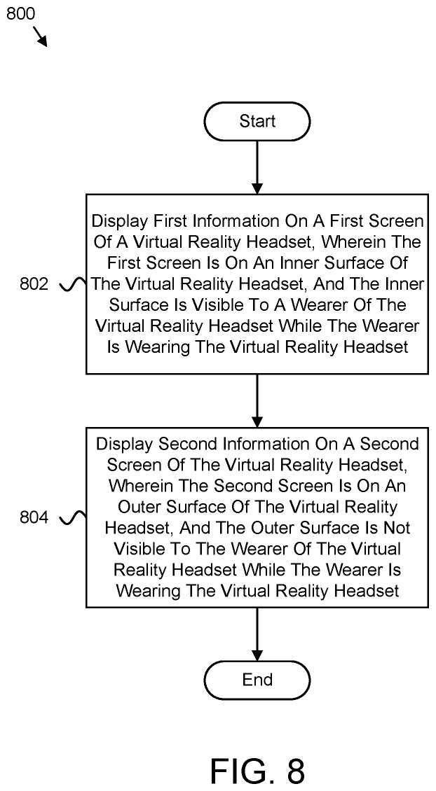

FIG. 8 is a schematic flow chart diagram illustrating an embodiment of a method 800 for displaying information on the virtual reality headset 108. In some embodiments, the method 800 is performed by an apparatus, such as the information handling device 102. In other embodiments, the method 800 may be performed by a module, such as the virtual reality display module 104. In certain embodiments, the method 800 may be performed by a processor executing program code, for example, a microcontroller, a microprocessor, a CPU, a GPU, an auxiliary processing unit, a FPGA, or the like.

The method 800 may include displaying 802 first information on a first screen (e.g., the first screen 600) of a virtual reality headset (e.g., the virtual reality headset 108). In the method 800, the first screen may be on an inner surface (e.g., the inner surface 502) of the virtual reality headset, and the inner surface may be visible to a wearer of the virtual reality headset while the wearer is wearing the virtual reality headset. In certain embodiments, the first display module 302 may display 802 the first information on the first screen of the virtual reality headset. In some embodiments, the first information includes a virtual reality environment.

The method 800 may include displaying 804 second information on a second screen (e.g., the second screen 700) of the virtual reality headset, and the method 800 may end. In the method 800, the second screen may be on an outer surface (e.g., the outer surface 504) of the virtual reality headset, and the outer surface may not be visible to the wearer of the virtual reality headset while the wearer is wearing the virtual reality headset. In various embodiments, the second display module 304 may display 804 the second information on the second screen of the virtual reality headset. In some embodiments, the second information includes information related to a virtual reality environment experienced by the wearer. In certain embodiments, the second screen includes a touch-screen display. In various embodiments, the second screen is configured to display information while the wearer is not wearing the virtual reality headset. In some embodiments, the second screen is configured to display a time, an image, and/or a notification.

In certain embodiments, the method 800 includes receiving input from a user via the second screen. In such embodiments, the input may correspond to a virtual reality environment. In various embodiments, the method 800 includes enabling selecting an application, downloading an application, starting an application, interacting with application content, downloading an update, changing a setting, viewing a notification, and/or interacting with a notification via the second screen.

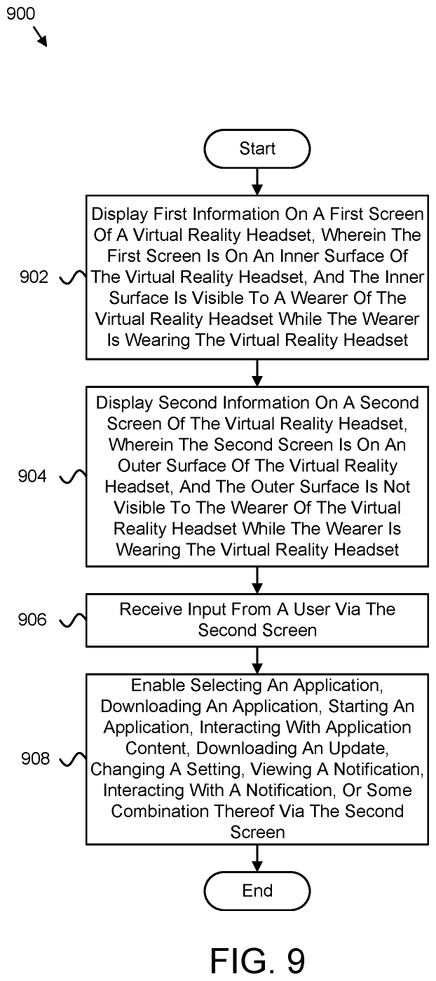

FIG. 9 is a schematic flow chart diagram illustrating another embodiment of a method 900 for displaying information on the virtual reality headset 108. In some embodiments, the method 900 is performed by an apparatus, such as the information handling device 102. In other embodiments, the method 900 may be performed by a module, such as the virtual reality display module 104. In certain embodiments, the method 900 may be performed by a processor executing program code, for example, a microcontroller, a microprocessor, a CPU, a GPU, an auxiliary processing unit, a FPGA, or the like.

The method 900 may include displaying 902 first information on a first screen (e.g., the first screen 600) of a virtual reality headset (e.g., the virtual reality headset 108). In the method 900, the first screen may be on an inner surface (e.g., the inner surface 502) of the virtual reality headset, and the inner surface may be visible to a wearer of the virtual reality headset while the wearer is wearing the virtual reality headset. In certain embodiments, the first display module 302 may display 902 the first information on the first screen of the virtual reality headset. In some embodiments, the first information includes a virtual reality environment.

The method 900 may include displaying 904 second information on a second screen (e.g., the second screen 700) of the virtual reality headset. In the method 900, the second screen may be on an outer surface (e.g., the outer surface 504) of the virtual reality headset, and the outer surface may not be visible to the wearer of the virtual reality headset while the wearer is wearing the virtual reality headset. In various embodiments, the second display module 304 may display 904 the second information on the second screen of the virtual reality headset. In some embodiments, the second information includes information related to a virtual reality environment experienced by the wearer. In certain embodiments, the second screen includes a touch-screen display. In various embodiments, the second screen is configured to display information while the wearer is not wearing the virtual reality headset. In some embodiments, the second screen is configured to display a time, an image, and/or a notification. As may be appreciated, the content displayed on the second screen is able to be interacted with while the virtual reality headset is not worn by the wearer and/or while the virtual reality headset is worn by the wearer. For example, the wearer (or another user) can interact with content on the second screen prior to donning the virtual reality headset. As another example, a user besides the wearer of the virtual reality headset can interact with content on the second screen while the wearer is donning the virtual reality headset.

In certain embodiments, the method 900 may include receiving 906 input from a user via the second screen. In such embodiments, the input may correspond to a virtual reality environment. In various embodiments, the input module 402 may receive 906 input from the user via the second screen.

In some embodiments, the method 900 may include enabling 908 selecting an application, downloading an application, starting an application, interacting with application content, downloading an update, changing a setting, viewing a notification, and/or interacting with a notification via the second screen, and the method 900 may end. In certain embodiments, the action module 404 may enable 908 selecting an application, downloading an application, starting an application, interacting with application content, downloading an update, changing a setting, viewing a notification, and/or interacting with a notification via the second screen.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a virtual reality headset comprising:
an inner surface visible to a wearer of the virtual reality headset while the wearer is wearing the virtual reality headset;
an outer surface not visible to the wearer of the virtual reality headset while the wearer is wearing the virtual reality headset;
a first screen on the inner surface; and
a second screen on the outer surface, wherein the second screen is configured to display information while both of the wearer is not wearing the virtual reality headset and the second screen is part of the virtual reality headset.

2. The apparatus of claim 1, wherein the first screen is at least part of a virtual reality screen.

3. The apparatus of claim 1, wherein the second screen is configured to display information related to a virtual reality environment experienced by the wearer.

4. The apparatus of claim 1, wherein the second screen comprises a touch-screen display.

5. (canceled)

6. A method comprising:
displaying first information on a first screen of a virtual reality headset, wherein the first screen is on an inner surface of the virtual reality headset, and the inner surface is visible to a wearer of the virtual reality headset while the wearer is wearing the virtual reality headset; and
displaying second information on a second screen of the virtual reality headset, wherein the second screen is on an outer surface of the virtual reality headset, the outer surface is not visible to the wearer of the virtual reality headset while the wearer is wearing the virtual reality headset, and the second screen is configured to display information while both of the wearer is not wearing the virtual reality headset and the second screen is part of the virtual reality headset.

7. The method of claim 6, wherein the first information comprises a virtual reality environment.

8. The method of claim 6, wherein the second information comprises information related to a virtual reality environment experienced by the wearer.

9. The method of claim 6, wherein the second screen comprises a touch-screen display.

10. (canceled)

11. The method of claim 6, further comprising receiving input from a user via the second screen.

12. The method of claim 11, wherein the input corresponds to a virtual reality environment.

13. The method of claim 6, further comprising enabling selecting an application, downloading an application, starting an application, interacting with application content, downloading an update, changing a setting, viewing a notification, interacting with a notification, or some combination thereof via the second screen.

14. The method of claim 6, wherein the second screen is configured to display a time, an image, a notification, or some combination thereof.

15. A program product comprising a computer readable storage medium that stores code executable by a processor, the executable code comprising code to perform:
displaying first information on a first screen of a virtual reality headset, wherein the first screen is on an inner surface of the virtual reality headset, and the inner surface is visible to a wearer of the virtual reality headset while the wearer is wearing the virtual reality headset; and
displaying second information on a second screen of the virtual reality headset, wherein the second screen is on an outer surface of the virtual reality headset, the outer surface is not visible to the wearer of the virtual reality headset while the wearer is wearing the virtual reality headset, and the second screen is configured to display information while both of the wearer is not wearing the virtual reality headset and the second screen is part of the virtual reality headset.

16. (canceled)

17. The program product of claim 15, wherein the executable code comprises code to perform receiving input from a user via the second screen.

18. The program product of claim 17, wherein the input corresponds to a virtual reality environment.

19. The program product of claim 15, wherein the executable code comprises code to perform enabling selecting an application, downloading an application, starting an application, interacting with application content, downloading an update, changing a setting, viewing a notification, interacting with a notification, or some combination thereof via the second screen.

20. The program product of claim 15, wherein the second screen is configured to display a time, an image, a notification, or some combination thereof.
